(19) United States
(12) Patent Application Publication
(10) Pub. No.: US 2021/0150587 A1
(43) Pub. Date: May 20, 2021

(54) ENGAGEMENT ANALYTICS ON MIXED DIGITAL/PHYSICAL PLATFORMS

(71) Applicants: Ali Rizvi, Toronto (CA); Syed Hammadullah Fasih, Scarborough (CA); Hammad Ahmed Naseem, Toronto (CA); Abdur Rahim Khanani, Toronto (CA)

(72) Inventors: Ali Rizvi, Toronto (CA); Syed Hammadullah Fasih, Scarborough (CA); Hammad Ahmed Naseem, Toronto (CA); Abdur Rahim Khanani, Toronto (CA)

(21) Appl. No.: 17/080,704

(22) Filed: Oct. 26, 2020

Related U.S. Application Data
(60) Provisional application No. 62/935,607, filed on Nov. 14, 2019.

(51) Int. Cl. G06Q 30/02; G06Q 30/06

(52) U.S. Cl. CPC G06Q 30/0276; G06Q 30/0244; G06Q 30/0621; G06Q 30/0267; G06Q 30/0246

(57) ABSTRACT

Embodiments described herein relate generally to data analytics and asset distribution technologies on physical objects. In particular, physical marketing collateral may integrate wireless and/or wired communication, cloud-based portal, and data analytics to provide a mixed digital/physical information exchange platform. Digital assets may be hosted on a cloud. Physical objects may be configured to display these assets on an internet-enabled device. The physical objects may be distributed among a plurality of end-users who may engage with theaw assets. Engagement with the digital assets may be monitored, aggregated and subjected to a variety of calculations to evaluate various analytics which quantify performance of the digital assets. At any time, the digital assets may be changed on the cloud, remotely updating the digital assets accessed via the associated physical objects. The ‘look and feel’ of both the physical objects and the cloud-based portal may be customized to meet branding standards and requirements.

### BACKGROUND OF THE INVENTION

### Field of Invention

Embodiments described herein relate generally to data analytics and digital asset distribution technologies on physical marketing collateral.

### Description of the Related Art

Marketing is the driving engine of sales. Digital marketing has exploded recently because of the immense power it offers for collecting and measuring data analytics to evaluate performance of marketing initiatives. The insights obtained can then be used to optimize the marketing strategy. Because of the virtual nature of these digital initiatives, updates can be readily implemented in real-time without much delay.

In contrast, physical marketing collateral such as flyers, brochures, direct mail, cards, posters, business cards, billboards, signage, direct mail, newsletters, magazines, catalogs, promotional merchandise, data storage media, video brochures, webkey-based products, custom-branded products, among others, have lagged behind because of their inability to provide a measure of engagement and hence, return-on-investment (ROI). Even if such information becomes available through cumbersome surveys and complex investigative analyses, changes cannot be implemented once the physical marketing material has been distributed, making feedback-driven optimization extremely challenging. Typically, new marketing material needs to be issued with the updates, rendering the update process extremely wasteful, and time-consuming.

Some existing technologies are able to address these issues to a limited degree by integrating physical objects with wireless communication modules e.g. two dimensional codes to launch additional digital assets (e.g. a website, a social media profile etc.) on mobile devices when scanned. While these methods of accessing digital assets are effective, most do not provide analytics for user engagement with the digital assets. Even if analytics are made available, they are highly error-prone because they track the activity associated with a specific physical object, which could change ‘hands’ multiple times and introduce inaccuracies in the analytics, which are primarily computed to evaluate user-activity instead of object-activity. Furthermore, once the physical objects have been distributed, the digital asset is difficult to update because the communication module must be reprogrammed, or in some cases, replaced. For instance, if a business prints a two-dimensional code on a physical object which is programmed to launch the website of the business, and the business later wants to change the website address, new physical objects will need to be issued with the updated two-dimensional code. This makes the process wasteful, and time-consuming. Furthermore, most existing solutions integrate a variety of third-party platforms which create additional issues with brand consistency, as many of these platforms have almost no, or very limited customizability of the visual interface. This interferes with the branding effort of businesses. It is highly desirable that a consistent brand be portrayed to prospects and customers so that a more robust and memorable brand identity can be established.

There is a need for improving devices, methods, and systems for: (1) generating audience engagement information in physical marketing collateral, (2) introducing the ability to remotely update digital assets accessed via marketing collateral which have already been distributed without the need of re-issuing completely new batches of the physical marketing collateral, (3) creating features to customize the visual elements of the digital/physical platform so that it is consistent with the brand identity of businesses, and (4) providing opportunities for digital content monetization.

### BRIEF SUMMARY OF THE INVENTION

It is to be understood that embodiments of inventive subject matter are not limited in their application to the details of construction and to the arrangements of the components set forth in the following description or the examples provided therein, or illustrated in the figures. Other embodiments are capable of being practiced and carried out in various manners. Also, it is to be understood that the phraseology and terminology employed herein are for the purpose of description and should not be regarded as limiting.

The presently disclosed system and methods can generally allow for obtaining engagement metrics with physical marketing collateral. It provides opportunities to remotely update the digital assets accessed using the physical marketing collateral, without the need to reprogram or reissue the physical marketing collateral. It provides opportunities for digital content monetization. It enables consistent branding across the physical marketing collateral and the interface which is used to access the digital assets, by allowing visual and functional customizations of the environment. Finally, digital assets accessed using the physical marketing collateral can be uniquely tailored for each end-user (e.g., based on content engagement history), as each physical marketing collateral is assigned a unique identifier.

According to an embodiment of the present invention, a mixed digital/physical platform is provided by integrating physical marketing collateral with digital environments, bringing engagement with physical objects into a digital context, and in turn, enabling collection of data associated with these engagement activities. An established quantity, N, of the physical marketing collateral may have integrated therein at least one unique identifier for each of the N units of the marketing collateral in the form of a uniform resource locator (URL). This URL may be communicated to a mobile device or computer via at least one wired or wireless communication module such as, but not limited to a USB interface, near-field communication (NFC), radio-frequency identification (RFID), Bluetooth, Wi-Fi, two-dimensional codes, etc. Upon establishment of communication, the URL may be launched on the device and a cloud-based portal hosting digital assets may become available. Engagement activity with the digital assets is collected and subjected to a variety of calculations to quantify various metrics that represent degree of user engagement with the digital assets. A dashboard may be provided to monitor and report the collected engagement analytics in real-time. In this manner, the system extends the power and flexibility of digital marketing to physical marketing collateral.

Another embodiment of the present invention also comprises of a cloud-based file management system which enables updating, removing, and adding, digital assets which could be accessed via the physical object. When changes are made to the digital assets using the file management system, the digital assets accessed via a physical object ‘remotely updates’ in real-time. In this manner, this system eliminates the need for reprogramming the communication module on the physical product, and also the need for issuing new physical marketing collateral.

Another embodiment of the present invention also comprises of a tracking interceptor for identifying an end-user. This may be in the form of a social media login, email-based login, or a locally-hosted user account. The digital asset may be accessed after the user has signed-in. In this manner, the system is able to track the activity of a specific user instead of tracking the activity associated with a physical product which may change ‘hands’ multiple times and introduce inaccuracies in the computed analytics. By tracking the activity of a user instead of a physical object, such inaccuracies in the engagement analytics can be eliminated.

Another embodiment of the present invention also offers a repository of predefined metrics that may be tracked to probe the degree of engagement of end-users with the digital assets. Businesses may be able to select multiple metrics from this repository, and may customize a dashboard which presents the selected metrics in real-time, and which, together, may effectively measure user engagement with the digital assets.

Another embodiment of the present invention also tracks how many ‘hands’ a specific physical object has exchanged by counting the number of unique user sign-ins with a specific physical object. This opens up the ability to quantify metrics that measure ‘viral’ activity for a physical object. One such metric is the ability to quantify indirect distribution of physical media, which may be thought of as the physical analogue of digital ‘reposting’ or ‘sharing’.

Another embodiment of the present invention also tracks the virtual ‘sharing’ of the digital asset accessed via the physical product opening up the opportunity to measure digital ‘viral’ activity. This may be in the form of sharing the digital assets over social networks, or otherwise.

Another embodiment of the present invention also comprises of an option to continue as guest without the need to sign-up or log-in to access the digital asset with the physical product. In this manner the system also preserves the privacy of users.

Another embodiment of the present invention also integrates the reported data analytics with other platforms including by way of example only a customer relationship manager (CRM), or a sales automation platform.

Another embodiment of the present invention also allows engagement analytics to be tracked separately for different marketing ‘projects’. In this way the system enables evaluation of performance of different marketing initiatives with respect to each other.

Another embodiment of the present invention also enables designing, personalizing, and customizing the physical marketing object. The customizations may be made on a varied selection of marketing collateral including but not limited to promotional merchandise (by way of example only: USB drives, video brochures, flyers, t-shirts, mugs, pens etc.) or fully-custom physical objects with customizability in shape, dimensions, form, material, printed text, images, and logos. In this way, the system allows the physical objects to meet the branding requirements of businesses.

Another embodiment of the present invention also enables customization of the user interface which may be used to access the digital asset. The online environment may be custom branded with the logo of the business, the color selection and themes may be changed to be aligned with the branding of the business, and the file/folder icons can be updated with any image file. In this way, the mixed physical/digital platform provides a seamless and consistent brand experience eliminating the interference in branding which occurs when a plurality of platforms are used, establishing a more robust and memorable customer association with the brand of a particular business.

Another embodiment of the present invention also downloads an application upon establishing a connection with a mobile device or computer so that the up-to-date digital asset can be accessed conveniently using the application, without needing to repeatedly use the physical object to access the digital asset. The thumbnail or icon image of the app may be customized to align with the branding requirements of the business.

Another embodiment of the present invention allows assigning privileges and permissions to each digital asset for different users and/or different user types. Permission may be granted to access the restricted digital assets, such as ‘premium’ assets, when certain conditions are met. One such condition may be the payment of a fee (one time, or subscription) for accessing the digital assets. In this manner, the system allows businesses to implement unique strategies, such as a ‘freemium’ model, and the like, and derive benefits that come concomitantly with such strategies.

Another embodiment of the present invention uses machine learning and artificial intelligence to recommend meaningful actionable optimizations for improving performance of their marketing initiative. One such optimization may come from the learning over time, what digital assets resonate most with a specific audience and use this information to make suggestions about what type of digital content should be shared next as it likely to also be received favorably by that audience.

Another embodiment of the present invention also allows businesses involved in marketing to build their own social media for their target audiences by integrating options to comment (in the form of text, images, and videos) and share the digital assets accessed via the physical marketing collateral.

Another embodiment of the present invention also allows the digital assets accessed via the physical marketing collateral to be uniquely tailored for each individual end-user based on said end-user's content engagement history.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows an overall system diagram of a possible implementation of the platform in accordance with one embodiment;

FIG. 2 presents a high level block diagram of how an administrator such as a digital asset owner may set-up the information exchange platform in accordance with an embodiment.

FIG. 3 presents a flowchart illustrating a method to manage digital assets in accordance with one embodiment.

FIG. 4 presents a flowchart illustrating a method to acquire customized physical marketing collateral that may provide access to the digital assets, in accordance with one embodiment.

FIG. 5 presents a few examples of how the communication modules may be integrated with the physical marketing collateral.

FIG. 6 presents a flowchart which represents one method of retrieving digital assets associated with an identifier of a physical product, in accordance with one embodiment.

FIG. 7 demonstrates a method for collecting, and measuring user engagement with the digital assets in accordance with one embodiment of the invention.

FIG. 8 presents a flowchart for assigning an identity to an end-user who uses the physical marketing collateral to access the associated digital assets, in accordance with one embodiment.

FIG. 9 provides an illustration of the dashboard which may present the engagement analytics results associated with a project to the administrator.

FIG. 10 provides an illustration of the user interface which hosts digital assets and which launches when physical marketing collateral establishes connection with an internet-enabled device.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

For the purposes of promoting an understanding of the principles of the invention, reference will now be made to the embodiments illustrated in the drawings and specific language will be used to describe the same. However, the illustrated embodiments are merely exemplary and many additional embodiments of this invention are possible. For example this invention is shown in use with a promotional USB drive; however this invention is not intended to be limited to USB drives. It is understood that no limitation of the scope of the invention is thereby intended. Any alterations and further modifications in the illustrated devices, and such further application of the principles of the invention as illustrated herein are contemplated as would normally occur to one skilled in the art to which the invention relates.

The disclosed system enables delivery of digital assets through physical marketing collateral. The digital assets may be provided by an administrator, which may be a representative of a business, or an owner of the assets, and may include a variety of media forms. These digital assets may be associated with physical marketing collateral. The physical marketing collateral and the user interface which may be used to access the digital assets may be customized to meet the branding standards, and printing expectations, of the administrator.

Once the physical marketing collateral has been distributed or shared, the associated digital asset may be accessed by the recipients of the physical marketing collateral, which may be a target audience. The recipients of the physical marketing collateral may be required to establish wired/wireless connectivity to a computer or a mobile device to access the digital assets. The recipients may be able to use the physical object to access the associated assets multiple times. In some embodiments, the recipients may be directed to install an app so that access to the assets may be granted without the need of the physical object. The recipients may also need to sign up, log in or continue as guest all of which may have different access privileges defined by the administrator.

In accordance with the systems and methods described herein, the assets are accessed via a user interface which may be customized to the branding standards of the business. Personalizations may be made so that continuity in ‘look and feel’ of a brand may be created across the mixed digital/physical platform. In addition, the interface may provide the ability to share the digital assets across various channels such as email, social networks, etc.

Whereas most physical objects may be deemed static, the digital assets are stored such that they can be manipulated over time by the administrator allowing ‘remote updating’ of the digital assets even after the physical objects have been deployed. Furthermore, other administrative features may be changed over time, such as but not limited to asset access permissions for different users, and the visual customizations of the interface. In some embodiments, the system may offer scheduling tools that could enable changes to the digital assets for implementation at a future predefined date.

The platform may provide a measurement of various metrics for tracking engagement with the digital assets accessed via the physical marketing collateral. The engagement analytics may be presented in the form of a dynamically updating dashboard to visualize various performance metrics. The platform may provide the ability to select a variety of engagement analytics metrics from a repository of predefined metric, or create custom user-defined metrics, including those that involve comparison across various projects or campaigns. In addition, this platform may implement rules that enable providing meaningful insights after analyzing the engagement results over time, and/or recommend optimizations for improving engagement performance. These insights may be made through recommendation notifications and may utilize machine learning and/or optimization methods, among other techniques.

This platform provides a scalable system that may have an ability to: (1) more accurately measure engagement analytics aggregated from a plurality of users, (2) more effectively update digital assets associated with physical marketing collateral even after the physical marketing collateral has been distributed, (3) more effectively adjust the “look and feel” of the physical marketing collateral and the user interface which hosts the digital assets so that a consistent, continuous, and uninterrupted brand image can be portrayed across the mixed digital and physical platform, (4) more effectively control and assign privileges to access restricted digital content for digital content monetization purposes.

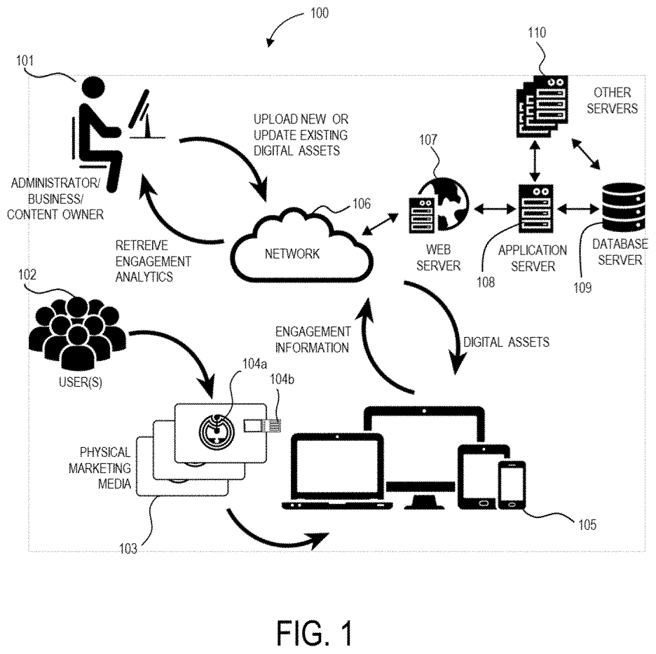

Referring now to FIG. 1, there is shown an overall implementation of the platform in accordance with one embodiment. Each element in this implementation environment 100 is described before the operation is explained.

In this implementation environment 100, there exists at least one administrator 101 who may be a business, an individual, sales staff, independent agent, franchisee, representative, marketing manager, account manager, researcher, ad agency, marketing firm, digital asset owner, solopreneur, and the like. The digital assets may be in a variety of formats which include without limitation, text, video, audio, images, virtual reality elements, augmented reality elements, vibrations, or a combination thereof.

The users 102 can be one person or a plurality of persons who may be considered prospective customers, target audience, digital asset consumers, recipients of physical marketing collateral, end-users, viewers of the marketing collateral, consumers, clients, customers or any combination thereof, and the like.

The physical marketing media 103 may include by way of example USB drives, flyers, brochures, cards, posters, business cards, billboards, signage, direct mail, newsletters, magazines, catalogs, notepads, calendars, stickers, invitation cards, booklets, books, banners, promotional merchandise, data storage media, packaging, video brochures, holograms, webkey-based products, custom-branded products, swag items, shirts, pens, mugs, bags, key-chains, fidget spinners, lanyards, bottle openers, stuffed toys, caps, clothing merchandise, and other physical marketing collateral, or a combination thereof. One physical marketing object 103 may serve one user 102 or it may serve multiple users 102. If desired, the physical marketing objects can be customized in shape, dimensions, form, material, printing method, printed text, printed images, printed logos, and the like. If a 2D or 3D display is made available in the marketing object itself such as in video brochures, then videos and projections may also be customized. Unique physical customizations to each unit of 103 may also be made. For instance, an alphanumeric set of characters which increase by +1 may be printed or stamped for a plurality of units of marketing collateral 103. In this way, the system may allow the physical objects to meet the branding requirements of businesses, and may provide additional opportunities for visual tracking of individual units.

The physical marketing objects 103 may embed some means of communicating with various devices using wireless/wired communication modules 104 including one or more of the following: QR code, linear code, two-dimensional code, NFC (104a), Bluetooth Low Energy (BLE), RFID, three-dimensional code, barcode, machine readable code, data over voice, near sound data transfer (NSDT), USB (104b), USB-type C, SD card, micro SD card, micro USB, mini USB, and the like.

The devices 105 may include any device connected to a network including a desktop computer, personal computer, workstation, server, portable computer, mobile device, personal digital assistant, laptop, tablet device, smart phone, WAP phone, smart glasses, holographic displays, virtual reality hardware, augmented reality hardware, smart television, video display terminals, smart watches, gaming consoles, electronic reading device, portable electronic devices or a combination of these, or other computing device with network connectivity. The device 105 may also be a third party computer network service such as a social networking platform that utilizes the engagement analytics, remote updating feature and/or the digital environment customization resources. The devices 105 may include at least one processor, may include any type of computer memory located either internally or externally, include one or more input devices, such as a keyboard, mouse, camera, touch screen and a microphone, and may also include one or more output devices such as a display screen and a speaker.

The devices 105 are coupled with a network 106 (or multiple networks) capable of carrying data including the internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The network 106 is communicatively coupled with any number of web servers 107, application servers 108, database servers 109, and other servers 110 (such as file management servers, analytics servers etc.). Alternatively, the system may employ a server through a cloud computing web service or a server farm communicatively coupled with one or more servers and/or data storage devices distributed over a wide geographical region and connected via the network. The servers may reside in any number of networked mobile devices or computers such as hardware server, mobile phones, gaming consoles, personal computers, laptops, workstations, tablets, smart televisions, and any combination thereof. The server may also be made of one or multiple social networking platforms. A variety of other configurations are possible. The server may comprise of any type of general-purpose microprocessor or microcontroller, a digital signal processing (DSP) processor, an integrated circuit, a field programmable gate array (FPGA), a reconfigurable processor, a programmable read-only memory (PROM), or any combination thereof. The server may include any type of computer memory that is located either internally or externally such as random-access memory (RAM), read-only memory (ROM), electro-optical memory, magneto-optical memory, erasable programmable read-only memory (EPROM), and electrically-erasable programmable read-only memory (EEPROM), Ferroelectric RAM (FRAM) or the like. The servers 107, 108, 109, 110 can utilize operating systems, such as Linux, and Linux variants.

The process depicted in FIG. 1 initiates when an administrator 101 uploads digital assets on the platform via a network 105. The administrator 101 may also customize the theme of the user interface which hosts the assets. The administrator 101 may use the platform to acquire custom-branded and personalized physical marketing collateral 103 for distribution among users 102. The users 102 may connect the physical marketing collateral 103 with a device 105 via a communication interface 104. The device 105 may be communicatively linked to the network 106. The users 102 may gain access to the digital assets associated with the physical marketing collateral 103 in a custom-branded interface which may be consistent with branding on the physical marketing collateral 103. The users 102 may engage with the digital assets. The engagement activity of users 102 may be monitored, and recorded. The engagement activity of a plurality of user 102 may be aggregated to calculate various performance metrics. Administrator 101 may use the platform to access the measured performance analytics, may formulate insights, independently or from recommendations of the platform, in order to optimize engagement. At a later date, the administrator 101 may choose to ‘remotely update’ the digital assets accessed via the physical marketing collateral 103 by simply manipulating the digital assets on the platform.

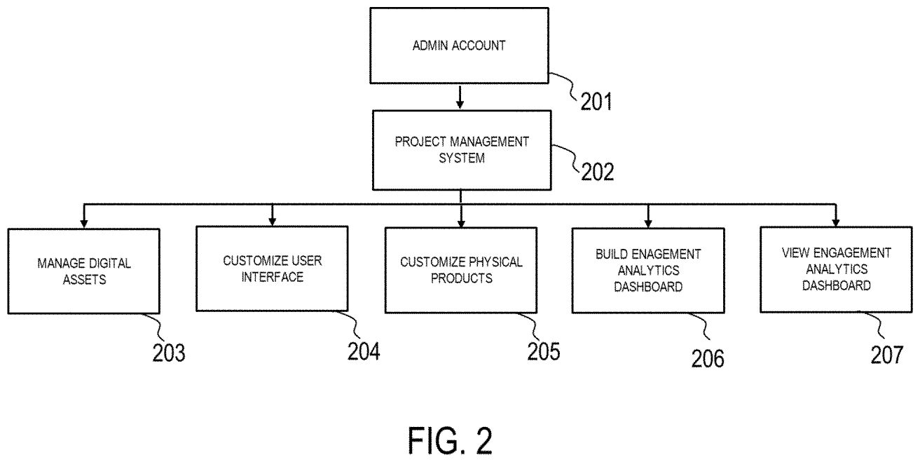

FIG. 2 presents a high level block diagram of how an administrator 101 may initiate the process in accordance with an embodiment. The administrator 101 may open an account and may sign in to their account 201 for gaining access to a project management system 202 where all projects and/or campaigns may be centralized. Upon selecting an existing project or creating a new one, the platform may enable: 1) management of the digital assets 203 linked to that project, where new digital assets may be uploaded, existing digital assets removed or updated, and permissions and privileges may be assigned to users individually or as a group; 2) customization of the user interface 204 associated with the project, which will be viewed by the users 102 and will host the digital assets; 3) customization of the physical products 205 related to that project and which will be associated with the digital assets; 4) setting up and/or building the dashboard which shows user engagement analytics 206 for the project, which may be achieved by selecting a series of predefined tracking-metrics from a repository and made available to the administrator; and 5) viewing the dashboard which presents user engagement analytics in real-time 207. An administrator 101 may have multiple projects each of which may have a different set of digital assets, different user audiences 102, different physical marketing collateral 103, and different tracked engagement metrics. Furthermore, engagement metrics between multiple projects may also be compared.

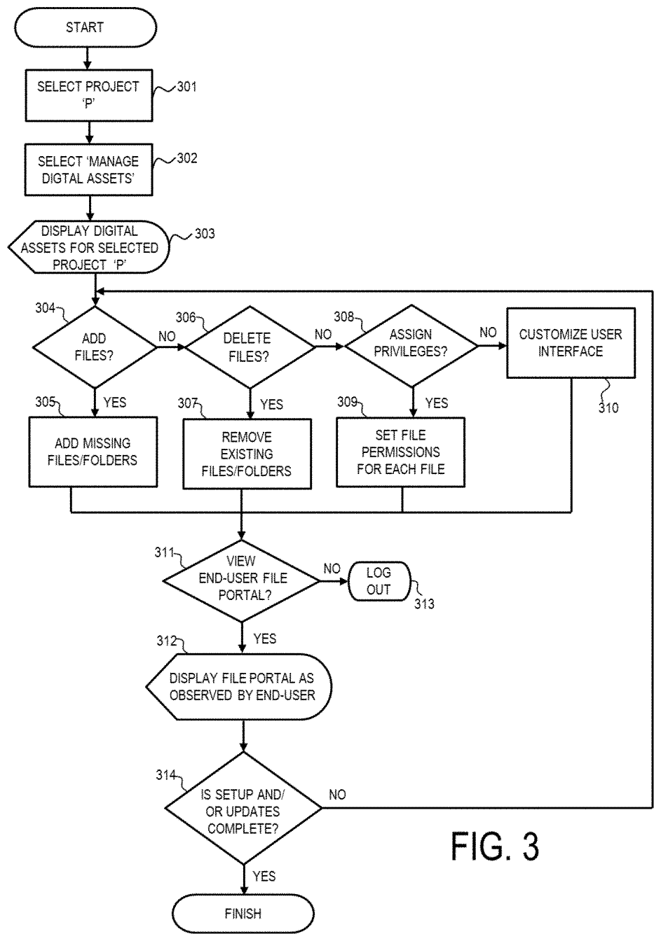

FIG. 3 presents a method to manage digital assets in accordance with one embodiment. The administrator 101 may use the project management system which shows a complete list of all existing projects or create new projects, to select a project 301. Once a project is selected, the administrator 101 may select the option “manage digital assets”, or equivalent, for the selected project 302. The digital assets associated with the selected project may be displayed 303. If no digital assets have been uploaded yet, this interface may be empty. New assets may be added 304 by including missing files, URLs, and folder 305, existing URLs, files and folders may be deleted 306 by removing existing URLs, files, and folders 307, or access-privileges to different URLs, files, and folders may be assigned for different users 102 at 308 by setting permissions for each file and folder 309. Dynamic privileges which change under certain conditions may also be assigned, such as but not limited to time-dependent access privileges wherein availability of digital assets may begin and end at preconfigured dates. Furthermore, cyclic privileges may also be assigned, where the assets become available to a certain group of users 103, during certain periods e.g. seasons, months, weeks, days, hours etc.

Furthermore, the user interface may be customized to replicate the look and feel of the brand of the administrator 310. This customization determines how the user interface hosting the digital assets will appear to the users 102. These customizations include icon and thumbnail images, company logo(s), banners, titles, headlines, descriptions, preview images, colors, themes, sorting, view type (large icons, small icons, list etc.), and the like. These customizations may be made from built-in options of the platform or completely user-defined. Once intended changes have been implemented, options are made available 311 to visualize the personalized user interface 312 as viewed from the perspective of a user, or user-category, or log out 313. The administrator 101 has the ability to update: 1) the digital assets, 2) permissions and privileges for accessing digital assets, and 3) visual customizations of the interface for each project as many times as needed over time 314. By doing so, the user interface and the digital assets accessed using the physical products 103 may also be remotely updated.

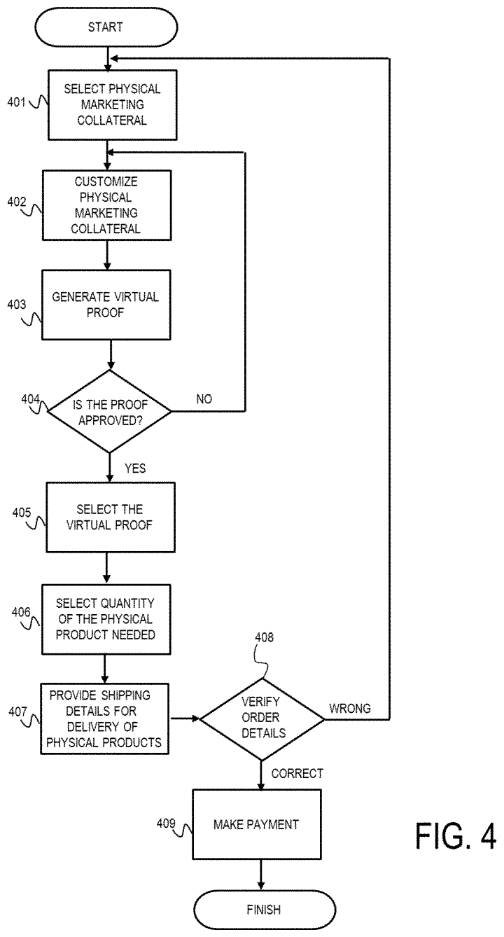

FIG. 4 presents a system to acquire customized physical marketing collateral 103 that may provide access to the digital assets, in accordance with one embodiment. At least one physical marketing object may be selected from a collection of products 401 made available to the administrator 101 to choose from. Customizations may be made to the selected physical marketing collateral 402. Customizations may be made through the online ‘portal’ by the administrator 101, with the assistance of a design service, or through other mediums. The design service may be provided via the platform or arranged otherwise. At the completion of the customizations, a virtual proof may be generated which may provide an adequate representation of how the physical marketing collateral will look after production 403. Changes may be applied as many times as needed until the final form of the marketing collateral is acceptable 404. Once the finalized virtual proof is selected 405, the quantity of the physical marketing collateral may need to be provided for manufacturing 406. At least one shipping address may also need to be provided as a destination where the manufactured physical marketing collateral may be delivered 407. A plurality of shipping addresses may be provided if the physical marketing collateral 103 is to be shipped directly to a plurality of users 102 such as in the case of a direct mail campaign. The unique customizations for each unit may include incremental numbering, codes, or otherwise. The unique customizations for each unit may provide additional tracking opportunities, and hence, opportunities to tailor the digital assets viewed by each end-user. Furthermore, it will provide end-users to buy specific restricted digital assets allowing monetization opportunities. Finally, the administrator 101 may verify the specifications of the customized physical marketing collateral, the quantity, and/or shipping details 408 before continuing with making payment 409 for production and logistics.

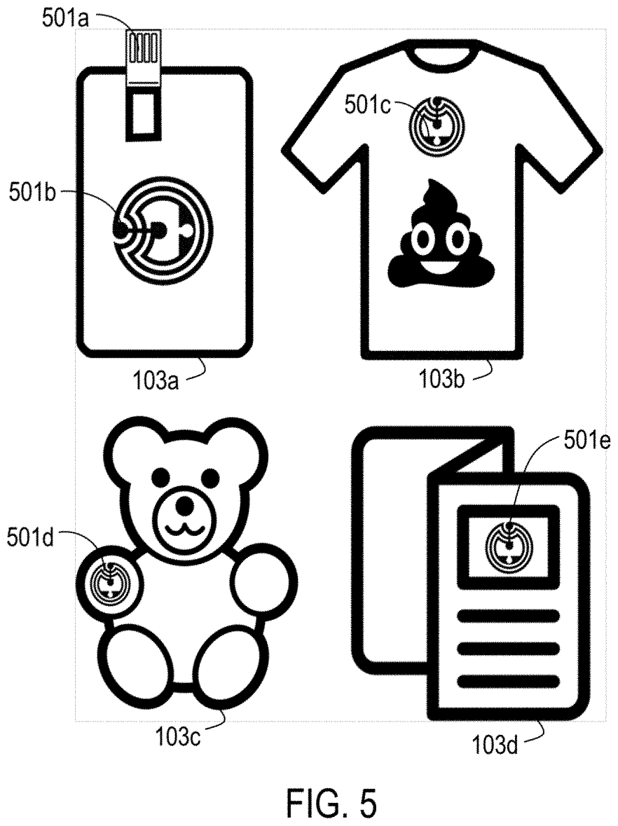

Each physical object integrates at least one wired or wireless communication module. The physical objects 103a-e included in FIG. 5a present a few examples of how the communication modules 501a-e may be integrated with the physical marketing objects. The figure includes a card 103a with one wired communicating module e.g. a USB module 501a which may connect to any USB port of a computer, as well as one wireless communicating module e.g. NFC circuit 501b, which can communicate wirelessly with any NFC-enabled device; a t-shirt 103b with a wireless communicating module 501c; a stuffed-toy 103c with a wireless communicating module 501d; and a brochure 103d with a wireless communicating module 501e. It is important to understand that these objects are included for illustrative purposes and are therefore not limiting. Additionally, the number of communication modules embedded in each object may exceed one, such as in the case of 103a.

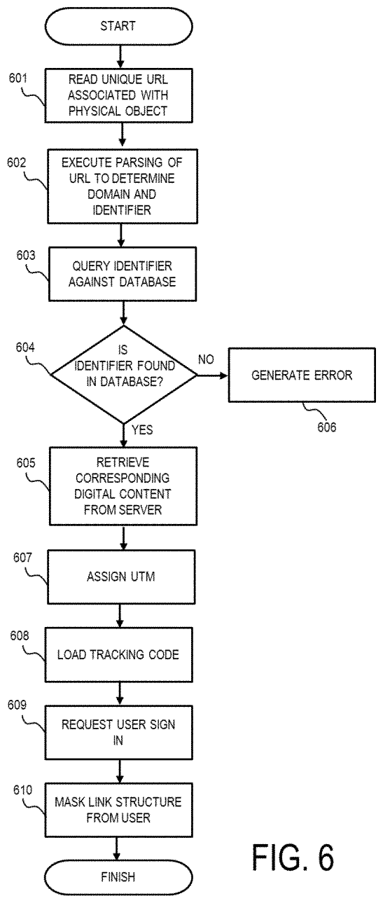

FIG. 6 shows a method to associate a physical object 103 with the digital assets in accordance with one embodiment. Each of the communication modules is preprogrammed with an identifier. This identifier may be in the form of a universal resource locator (URL) but could be in other forms as well. Identification may be achieved at an individual physical object level using a unique identifier for each object, or it may be achieved at a batch level using a unique identifier for each batch i.e. group of physical objects. A device 105 can read this URL when the physical object 103 establishes wireless or wired communication with the device 105 through the communication module. FIG. 6 presents a flowchart which represents one method of retrieving digital assets associated with an identifier of a physical product, in accordance with one embodiment. When device 105 reads the URL via a communication module 501 embedded in a physical product 103 in step 601, it invokes HTTPS protocols to call the web server 107 via the network 106. The application server 108 parses the URL to identify the unique identifier or batch identifier in step 602. The identifier is queried against a database 108 which hosts the complete table of valid identifiers 603. If a valid identifier is confirmed in step 604, the corresponding digital assets are retrieved 605, assigned urchin tracking modules (UTM) 607, loaded with tracking code 608, and presented to the user 102 via the customized user interface. If the identifier is not found, an error is generated 606. In some embodiments, the user 102 may be required to sign up, log in, or continue as guest 609, before permission to access is granted and the privileges of each account may be set by the administrator 101. The retrieved web link structure may be masked from the user 102 at step 610.

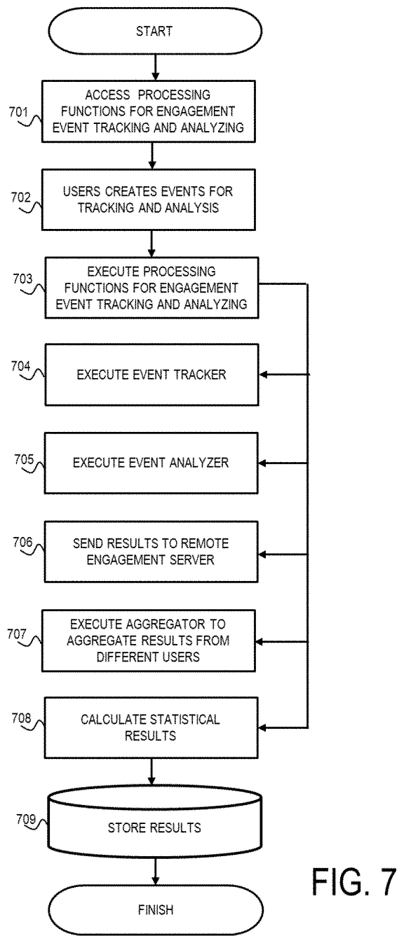

FIG. 7 demonstrates a method for collecting, and measuring user engagement with the digital assets in accordance with one embodiment of the invention. The administrator decides which events may be tracked and what analysis may need to be performed on the tracked events to quantify engagement with the digital assets. The event tracking and analyzing options may be selected from a repository of predefined event trackers and analyzers made available through the platform or otherwise. The user interface which presents the digital assets to users is tagged with processing functions i.e. code is implemented at appropriate places within the interface so that information on relevant user-behavior can be collected to compute the corresponding engagement metrics. When the user interface is launched, the relevant code is fetched for tracking and analyzing engagement events 701. This code may be retrieved from an engagement server, may be stored locally on the webpage, may be hosted by a third party analytics solution, or in other ways. At 702, the user engages with the digital assets, creating low-level trackable events like viewing, downloading, mouse movement, scrolling, selecting, highlighting, magnifying, pausing, spending time, clicking, and the like. Information on these engagement events is collected and processed to compute the specified metrics 703. In order to accomplish this, an event tracker code is executed which tracks specific events created by the user 102 at 704. When some events have been tracked, the event analyzer is executed which processes the tracked events 705. What analyses are conducted is determined by the administrator 101. The event tracking 704 and the event analysis 705 may be conducted locally on the device of user 102 in accordance with the method established by US20140344455A1 or remotely. Once the results of the event tracking 704 and analyses 705 have been obtained, the results are sent to a remote engagement server 706. Since a plurality of users 102 may engage with the same digital assets, the results from a multitude of users may be sent to the remote engagement server at 706. An aggregator is subsequently executed to aggregate the results from different users at 707. The results are subsequently subjected to various statistical analyses to generate statistics representing engagement 708. The calculated statistical results are stored 709 and may be dynamically updated and presented to the administrator 101 e.g. through the dashboard discussed in 207.

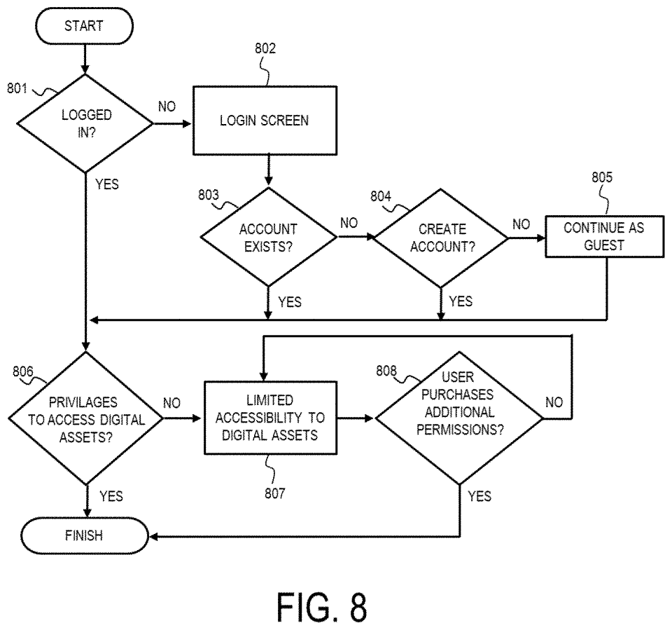

FIG. 8 presents a flowchart for assigning an identity to an end-user 102 prior to showing the digital assets to the user, in accordance with one embodiment. This method employs a tracking interceptor which may be in the form of a sign-in request. By allowing a user to sign-in, the system may be able to track the activity of a specific user instead of tracking the activity associated with a physical product which could change ‘hands’ multiple times and introduce inaccuracies in the computed analytics. By tracking the activity of a user instead of a physical object, such inaccuracies in the engagement analytics can be eliminated. Furthermore, additional understanding of a specific user's behavior may also be understood for targeted marketing purposes on various other channels such as social media and digital marketing. The system first establishes whether the user 102 is already logged in 801. If the user 102 is not logged in, a log in screen appears 802, where a user who already has an account may sign in 803. The user may sign in via a social network account, an email service provider such as Gmail®, or via an account hosted by the platform itself. In the case where neither accounts exist, the user 102 may be requested to create an account 804. Because privacy is becoming an increasingly important factor in online presence, an option may be made available wherein the user 102 may continue as guest 805, without needing to create an account or signing in. The platform may subsequently check the user privileges and permissions preset by the administrator 101, to present the digital assets 806. In the situation where partial permission is granted, limited access to the digital assets may be made 807. The unavailable assets may either be ‘grayed out’ or not visible at all. The user 102 may be provided an option to purchase additional permissions to gain access to such ‘grayed out’ assets 808.

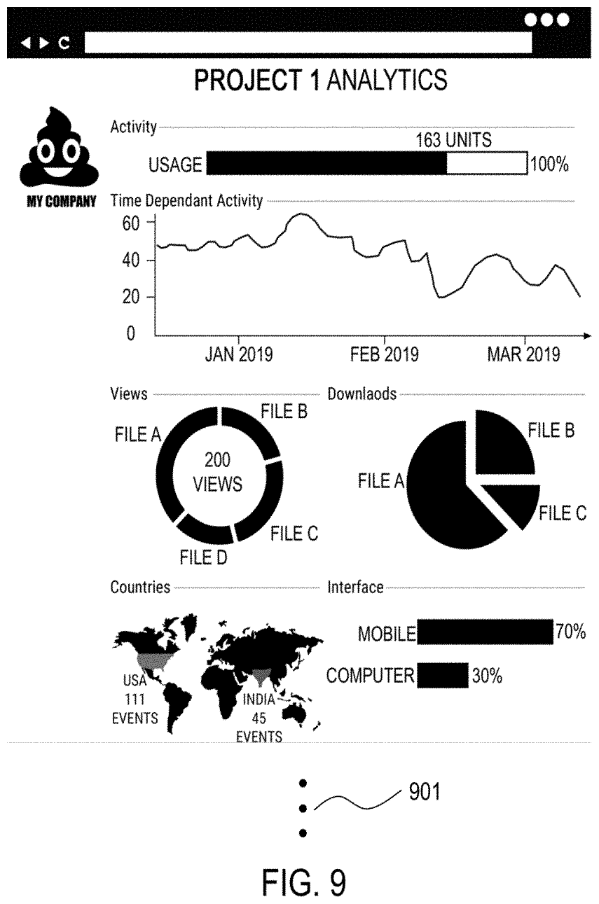

FIG. 9 provides an illustration of the dashboard which may present the engagement analytics results associated with a project to the administrator 101. The metrics included in the dashboard may be selected from a series of options made available to the administrator 101. While the dashboard illustrates a few example metrics, many more metrics may be included in this dashboard 901. The metrics may be presented in various visual forms such as bar charts, 2D graphs, 3D graphs, aggregated data sets, heat maps, pie charts, tables, line charts, time-dependent behaviors, and the like. The data may be readily exported and transmitted to different systems for further processing. The dashboard may allow inter-project comparison of the metrics.

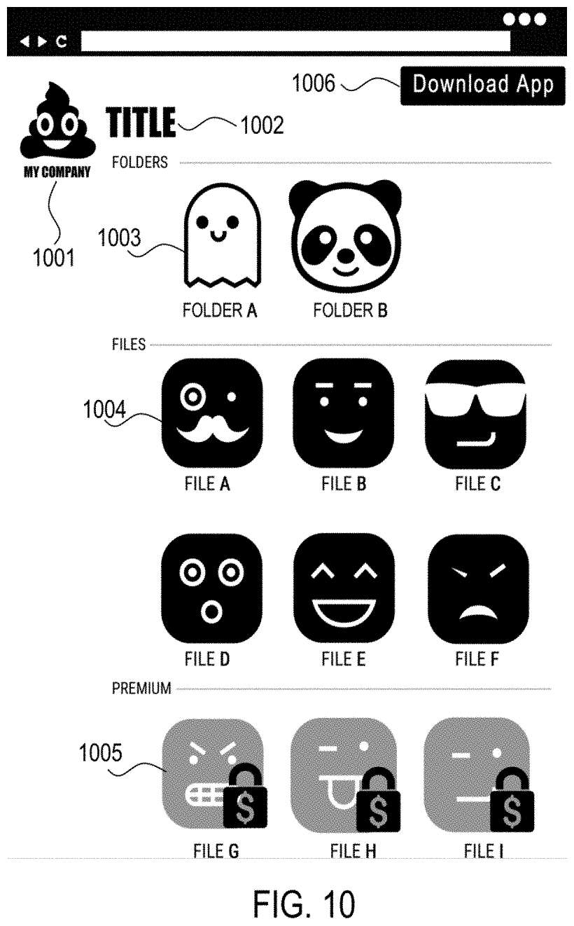

FIG. 10 provides an example illustration of the user interface which launches when physical marketing collateral establishes connection with a device 105. The visual elements such as the company logo 1001, the title 1002, individual folder icons 1003, individual file icons 1004, the stylistic elements of the overall webpage e.g. background, font style, font color, button color, and so on, may be customized to optimize the look so that it aligns with the branding requirements of the administrator 101. Furthermore, ‘grayed out’ or inaccessible digital assets may be made available to the user 102, upon purchase 1005. The individual URLs, files, and folders may be viewed or streamed online, may be downloaded, or maybe shared on other platforms such as social networks, depending on the permissions set by the administrator 101. Furthermore, the entire set of digital assets may be downloaded as an ‘app’ on to the user device 104, so that the digital assets may be accessed without needing to establish connection with the physical object using a button 1006. The stylistic elements and the ‘look and feel’ of the interface may remain preserved in the downloaded app, although additional features and means of interacting with users may become possible e.g. mobile phone notifications, swiping etc. which may not be possible through a web browser.

The mixed physical/digital platform for distributing digital assets with integrated tracking and customization may be applied across multiple verticals. As an example the platform may have application in administration where the utilization of the digital assets by user groups such as employees, agents, etc. may be monitored using the engagement analytics dashboard.

Another example application may be in the education industry, where teachers may be able to monitor the engagement of students with course-related digital assets, and use this information for grading students, and/or developing a more optimized course curriculum.

Although the disclosure has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the claims.

Except to the extent explicitly stated or inherent within the processes described, including any optional steps or components thereof, no required order, sequence, or combination is intended or implied. As will be understood by those skilled in the relevant arts, a wide range of variations is possible, and even advantageous, in various circumstances, without departing from the scope of the invention, which is to be limited only by the claims.

1. A method of integrating digital assets with physical objects, comprising:
at least one physical object; and
at least one communication module embedded in the physical object which can establish wired and/or wireless communication with an internet-enabled device; and
a cloud-based data storage and management system where the digital assets are stored; and
a user interface which allows end-users to access the digital assets; and
a data analytics system which can measure end-user engagement with the digital assets.

2. The method of claim 1 wherein a database of engagement analytics functions is made available to the administrator to choose from for tracking engagement of users with the digital assets accessed via the physical object.

3. The method of claim 1, wherein engagement analytics functions from a third party service can be made available to the administrator for tracking user engagement with the digital assets, including a customer relationship manager (CRM), and/or a sales automation service.

4. The method of claim 1, wherein a dashboard is made available for reporting the selected engagement analytics functions to the administrator, and where the computed metrics can be exported for further analysis and processing.

5. The method of claim 1 wherein the administrator can assign and update permissions and privileges of different users for accessing the digital assets.

6. The method of claim 1 wherein the restricted digital assets may be purchased by end-users via a payment interface to gain access to the said assets.

7. The method of claim 1, wherein the physical object may be physical marketing collateral.

8. The method of claim 1, wherein the physical object may be customized.

9. The method of claim 1, where the file storage and management system allows updating of the digital assets so that the content accessed via the physical objects may be ‘remotely updated’ even after the physical objects have been distributed to end-users.

10. The method of claim 1, wherein the tracked metrics could be analyzed by a machine learning algorithm to recommend optimizations for improving digital asset performance.

11. The method of claim 1, where a tracking interceptor is present for identifying an end-user, which may be in the form of social network login, email-based login, or a user account hosted locally on the platform.

12. The method of claim 1, wherein the digital assets can be made available to end-users based on a predetermined schedule established by the administrator.

13. The method of claim 1, where the user interface can be visually personalized enabling it to meet the branding requirements and standards of the administrator.

14. The method of claim 13, where the personalized interface may be downloaded to an internet-enabled device belonging to an end-user in the form of an ‘app’ so that the physical object is no longer needed to access the digital assets.

15. The method of claim 14, where the thumbnail or icon ‘app’ can be customized so that it meets the branding expectations of the administrator.
